(19) United States
(12) Patent Application Publication
(10) Pub. No.: US 2026/0084678 A1
(43) Pub. Date: Mar. 26, 2026

(54) MECHANICAL FAILURE DETECTION IN ELECTROMECHANICAL BRAKE SYSTEMS

(71) Applicant: HL MANDO CORPORATION, Gyeonggi-do (KR)

(72) Inventors: Prakhar RAI, Auburn, MI (US); Jeremy DOBBS, Auburn, MI (US)

(21) Appl. No.: 19/324,460

(22) Filed: Sep. 10, 2025

Related U.S. Application Data
(60) Provisional application No. 63/697,435, filed on Sep. 20, 2024.

(51) Int. Cl. B60T 17/22

(52) U.S. Cl. CPC B60T 17/221

(57) ABSTRACT

An electromechanical brake (EMB) system is provided. The EMB system includes: a brake rotor configured to be rotatable with a wheel of a vehicle; a brake pad assembly configured to be engageable with the brake rotor; an actuator assembly including an electric motor configured to mechanically move the brake pad assembly toward or away from the brake rotor; and an electronic control unit (ECU) that performs operations. The operations include: obtaining a first pad travel distance using an estimated pad travel distance and a pad home position of a brake pad of the brake pad assembly; obtaining a second pad travel distance using a maximum load pad travel distance and the pad home position of the brake pad; and determining, using the first pad travel distance and the second pad travel distance, whether mechanical failure has occurred in the EMB system.

### CROSS REFERENCE TO PARENT APPLICATIONS

This application claims the benefit of U.S. patent application Ser. No. 63/697,435 filed on Sep. 20, 2024, entitled “GEAR WEAR/BELT SLIP DETECTION (MECHANICAL FAILURE)”, the entirety of which is incorporated herein by reference.

### BACKGROUND

Various embodiments of the present disclosure generally relate to an electromechanical brake (EMB) system (also referred to herein as an “EMB assembly”) and more particularly to a system and method for thermal management of the EMB system.

A brake system for a motor vehicle, and in particular an automotive vehicle, functionally reduces the speed of the vehicle or maintains the vehicle in a rest position. Various types of brake systems are commonly used in automotive vehicles, including hydraulic, anti-lock or “ABS,” EMB systems, and electric or “brake by wire.”

For example, in a hydraulic brake system, the hydraulic fluid transfers energy from a brake pedal to a brake pad for slowing down or stopping rotation of a wheel of the vehicle. In an electric brake system, the application and release of the brake is controlled by an electric caliper via electrical signal. The electric brake system typically includes an electric actuator connected to a brake caliper either by a cable, as the drum in head, or directly attached to the brake caliper. The electric actuator converts electrical power to rotational mechanical output power for moving the cable or drive screw and applying the brakes.

### SUMMARY

The features and advantages of the present disclosure will be more readily understood and apparent from the following detailed description, which should be read in conjunction with the accompanying drawings, and from the claims which are appended to the end of the detailed description.

According to various embodiments of the present disclosure, an electromechanical brake (EMB) system may comprise: a brake rotor configured to be rotatable with a wheel of a vehicle; a brake pad assembly configured to be engageable with the brake rotor; an actuator assembly comprising an electric motor configured to mechanically move the brake pad assembly toward or away from the brake rotor; and an electronic control unit (ECU) comprising a processor associated with a memory that stores instructions that when executed by the processor causes the ECU to perform operations. The operations may comprise: obtaining a first pad travel distance using an estimated pad travel distance and a pad home position of a brake pad of the brake pad assembly; obtaining a second pad travel distance using a maximum load pad travel distance and the pad home position of the brake pad; and determining, using the first pad travel distance and the second pad travel distance, whether mechanical failure has occurred in the EMB system.

The ECU is configured to perform the operations during a braking operation of the vehicle.

The second pad travel distance obtained using the maximum load pad travel distance and the pad home position of the brake pad is obtained concurrently with the first pad travel distance obtained using the estimated pad travel distance and the pad home position of the brake pad.

The pad home position is a distance between the brake rotor and the brake pad at a start of the braking operation of the vehicle before the brake pad is mechanically moved toward the brake rotor by the electric motor.

The estimated pad travel distance is determined using a motor angle of the electric motor that is measured during the braking operation.

The maximum load pad travel distance is a predetermined value that is stored in the memory of the ECU and indicates a maximum travel distance of the brake pad for the brake pad to reach a maximum pad compression against the brake rotor during the braking operation of the vehicle.

The ECU determines that the mechanical failure has occurred in the EMB system when the first pad travel distance exceeds the second pad travel distance.

The EMB system is a linear-position-sensor-less system that is configured without any sensors that directly measure a linear movement of the brake pad of the brake pad assembly.

The operations may further comprise: issuing, by the ECU, a mechanical fault flag; and receiving, in response to the mechanical fault flag, one or more instructions to place the EMB system in a safety mode of the EMB system.

The mechanical fault flag is issued to a central controller of the vehicle.

According to some embodiments of the present disclosure, a method for detecting mechanical failure in an electromechanical brake (EMB) system is provided. The method is executed by an electronic control unit (ECU) of the EMB system and comprises: obtaining a first pad travel distance using an estimated pad travel distance and a pad home position of a brake pad of a brake pad assembly of the EMB system; obtaining a second pad travel distance using a maximum load pad travel distance and the pad home position of the brake pad; and determining, using the first pad travel distance and the second pad travel distance, whether mechanical failure has occurred within the EMB system, wherein the EMB system comprises a brake rotor configured to be rotatable with a wheel of a vehicle on which the EMB system is installed, the brake pad assembly configured to be engageable with the brake rotor, and an actuator assembly comprising an electric motor configured to mechanically move the brake pad assembly toward or away from the brake rotor.

This Summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

Various embodiments in accordance with the present disclosure will be described with reference to the drawings, in which:

FIG. 1 shows a cross-sectional view of a brake assembly according to one or more exemplary embodiments of the present disclosure.

FIG. 2 shows a data flow diagram illustrating a method for mechanical failure detection in a brake assembly according to one or more exemplary embodiments of the present disclosure.

FIG. 3 shows a flow chart for illustrating a method for mechanical failure detection in a brake assembly brake assembly according to one or more exemplary embodiments of the present disclosure.

FIG. 4 shows a schematic view of a vehicle including a steering system and a brake assembly according to one or more exemplary embodiments of the present disclosure.

Corresponding numerals and symbols in the different figures generally refer to corresponding parts unless otherwise indicated. The figures are drawn to clearly illustrate the relevant aspects of the embodiments and are not necessarily drawn to scale.

### DETAILED DESCRIPTION OF EMBODIMENTS

In the following detailed description, reference is made to the accompanying drawings which form a part of the present disclosure, and in which are shown by way of illustration specific embodiments in which the invention may be practiced. These embodiments are described in sufficient detail to enable those skilled in the art to practice the invention, and it is to be understood that other embodiments may be utilized and that structural, logical and electrical changes may be made without departing from the spirit and scope of the invention. The following detailed description is therefore not to be taken in a limiting sense, and the scope of the invention is defined only by the appended claims and equivalents thereof. Like numbers in the figures refer to like components, which should be apparent from the context of use.

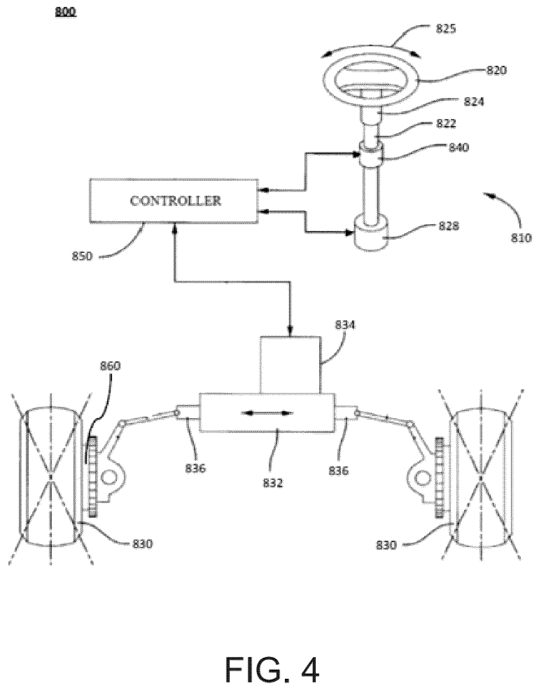

A vehicle (see, e.g., FIG. 4) may be equipped with one or more brake systems (e.g., an EMB system or the like) for slowing down or stopping rotation of a wheel of the vehicle (e.g., providing braking and stopping capabilities for vehicle). Due to their mechanical nature and compact structure, such brake systems may not always have space (e.g., footprint) for installation of one or more sensors (e.g., linear motion sensors, force sensors, or the like) that are vital for safe and optimal operation of these brake systems. For example, the linear motion sensors may be critical and/or necessary to determine a travel distance of one or more brake pads to ensure proper operations of these brake pads. Installation of such sensors may also unnecessarily and/or significantly increase the overall costs of the brake systems. However, a method for determining (e.g., diagnosis) whether mechanical failure has occurred without the use of such sensors (e.g., using readily available resources provided within such brake assemblies) is needed.

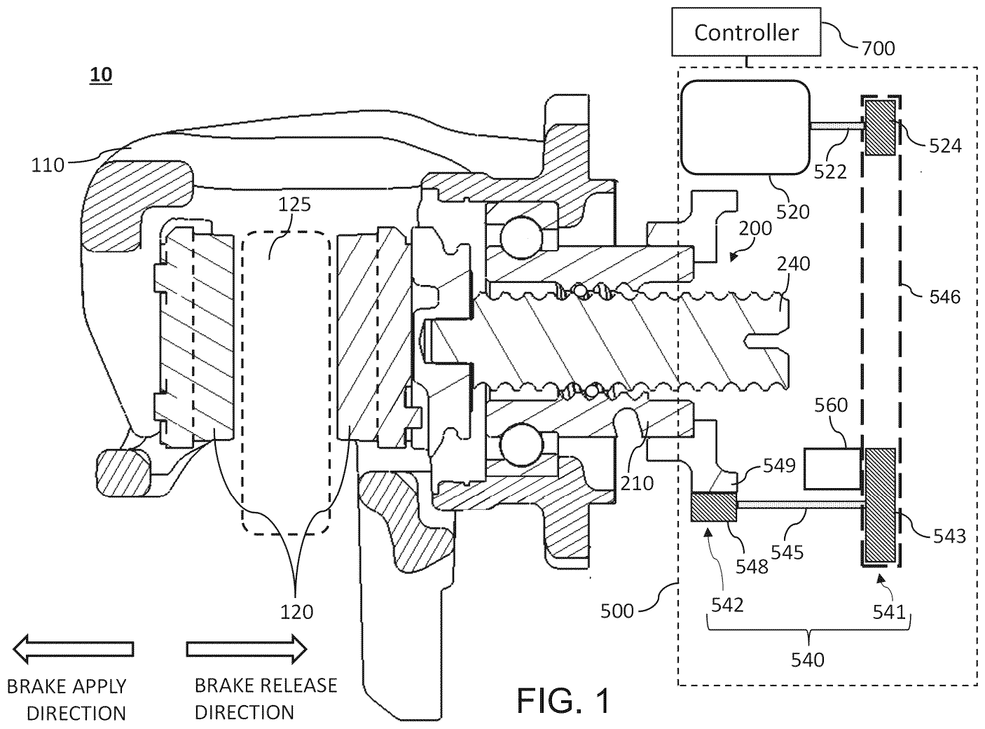

Referring to FIG. 1, a brake assembly 10 may include a brake caliper 110 mounted in a floating manner by means of a brake carrier. When the vehicle is in motion, a brake rotor 125 may rotate with a wheel about an axle of the vehicle. A brake pad assembly (or brake lining assembly) 120 (e.g., an electromechanical brake (EMB) system, or the like) is provided in the brake caliper 110. The brake caliper 110 may include a bridge with fingers, and the fingers of the brake caliper 110 may be in contact with the brake pad assembly 120. Each brake pad of the brake pad assembly 120 is disposed with a small air clearance on a side of the brake rotor 125, such as a brake disc, in a release position so that no significant residual drag moment occurs.

The brake assembly 10 may comprise a screw mechanism 200 (e.g., a ball screw mechanism or a nut-screw mechanism) configured to convert rotary motion generated by an actuator assembly 500 into linear motion in order to move the brake pad assembly 120 (namely, the right brake pad of the brake pad assembly 120) toward or away from the brake rotor 125 in an axial direction. The screw mechanism 200 may include a rotatable part 210 and a translatable part 240. For example, the rotatable part 210 may comprise a nut or a ball nut and the translatable part 240 may comprise a screw or a ball screw, although not required. The rotatable part 210 is operably coupled to the actuator assembly 500 and is configured to be rotatable by actuation of the actuator assembly 500.

The actuator assembly 500 may comprises the electric motor 520. For example, the electric motor 520 may be directly engaged with the rotatable part 210. Alternatively, the electric motor 520 is indirectly connected to the rotatable part 210 through means for transferring rotary force generated by the electric motor 520, such as one or more gears, one or more belts, one or more pulleys, and/or any other connecting means and combination thereof.

The actuator assembly 500 may have a multi-stage drive mechanism 540, although not required. The multi-stage drive mechanism 540 may be, for example, but is not limited to, a dual-stage drive mechanism comprising a belt drive mechanism 541 and a gear drive mechanism 542 to multiply torque from the electric motor 520 to supply rotary force to the rotatable part 210 of the drive mechanism 540. The belt drive mechanism 541 multiplies the torque from the electric motor 520 by using a drive pully 524 and a driven pulley 543 rotatably connected by a drive belt 546, and the torque multiplied by the belt drive mechanism 541 is delivered to the gear drive mechanism 542 through the intermediate shaft 545. The intermediate shaft 545 may connect the driven pulley 543 of the belt drive mechanism 541 to a first gear 548 of the gear drive mechanism 542 in order to deliver rotary torque, generated by the motor 520 and transmitted through the belt drive mechanism 541, to the gear drive mechanism 542. The first gear 548 is rotatably engaged with the second gear 549 to rotate the second gear 549 by the rotary torque transmitted through the intermediate shaft 545. The second gear 549 may be formed directly on a part of the circumferential surface of a rotatable body or nut of rotatable part 210 of the drive mechanism 540 or screw mechanism 200 or be mounted to the rotatable body of rotatable part 210 of the drive mechanism 540 to rotate the rotatable body or nut of rotatable part 210.

The mechanical connection between the electric motor 520 and the brake pad assembly 120 described above and illustrated in FIG. 1 is an example for illustration purposes only, and the present disclosure is not limited thereto. Any structure, configuration, and arrangement of the mechanical connection that can mechanically connect the electric motor 520 to the brake pad assembly 120 can be used.

Because the electric motor 520 and the brake pad assembly 120 are mechanically connected to each other, the movement of the brake pad assembly 120 (namely, movement in the right brake pad of the brake pad assembly 120) can cause the electric motor 520 to move. For instance, if the brake pad assembly 120 moves, a rotor of the electric motor 520 (e.g., the motor shaft 522) can rotate. Accordingly, if the brake pad assembly 120 moves in the brake release direction after the parking brake is applied, the displacement of the brake pad assembly 120 in the brake release direction can cause the rotor of the electric motor 520 (e.g., the motor shaft 522) to rotate due to the mechanical connection between the electric motor 520 and the brake pad assembly 120. As a result, a position of the electric motor 520 can be used to determine a linear position of the brake pad assembly 120, and vice versa.

To detect such changes in the linear position of the brake pad assembly 120, brake assembly 10 may further include a controller 700 that is able to measure a movement and/or position of the electric motor 520 (e.g., via one or more sensors not shown in FIG. 1) and a torque (e.g., motor torque) generated by the electric motor 520. The controller 700 may also be configured to control the electric motor 520 to perform braking operations of the brake assembly 10 (e.g., the above discussed movement of the translatable part 240 to cause the brake pad assembly 120 to engage with the brake rotor 125).

These one or more sensors may include any type and combination of sensors including, but not limited to: (i) motor position sensors, (ii) motor angle sensors; (iii) linear position sensors; (iv) temperature sensors; (v) current sensors; (iv) torque sensors; or the like. These one or more sensors may also be disposed (e.g., installed) within any portion of the brake assembly that is in proximity of the component or components that the sensors are configured to monitor and from which the sensors are configured to obtain measurements (e.g., obtain sensor readings from). In embodiments, the brake assembly 10 may not include any sensors (e.g., linear position sensors, or the like) for measuring linear movement of the brake pads of the brake pad assembly 120 (namely, the brake pad of the brake pad assembly 120 that is actuated by the translatable part 240 to clamp against the brake rotor 125. Essentially, in embodiments disclosed herein, the brake assembly 10 is a linear-position-sensor-less brake assembly 10.

The controller 700 may also be configured to receive instructions (e.g., digital instructions) from a main computing system (e.g., via a serial connection bus such as a controller area network (CAN), bus or the like) of the vehicle to modify one or more parameters and/or capabilities of the brake assembly 10. The main computing system of the vehicle may be, for example, a chassis controller or the like.

The controller 700 may be, for example, but not limited to, a micro-controller unit (MCU), an electronic control unit (ECU), a circuit chip, a semiconductor circuit, and a circuit board having memory (e.g., for storing instructions to be executed by one or more processors coupled to the memory), one or more processors, and electric components. The controller 700 may be coupled to (e.g., one or more components of) the actuator assembly.

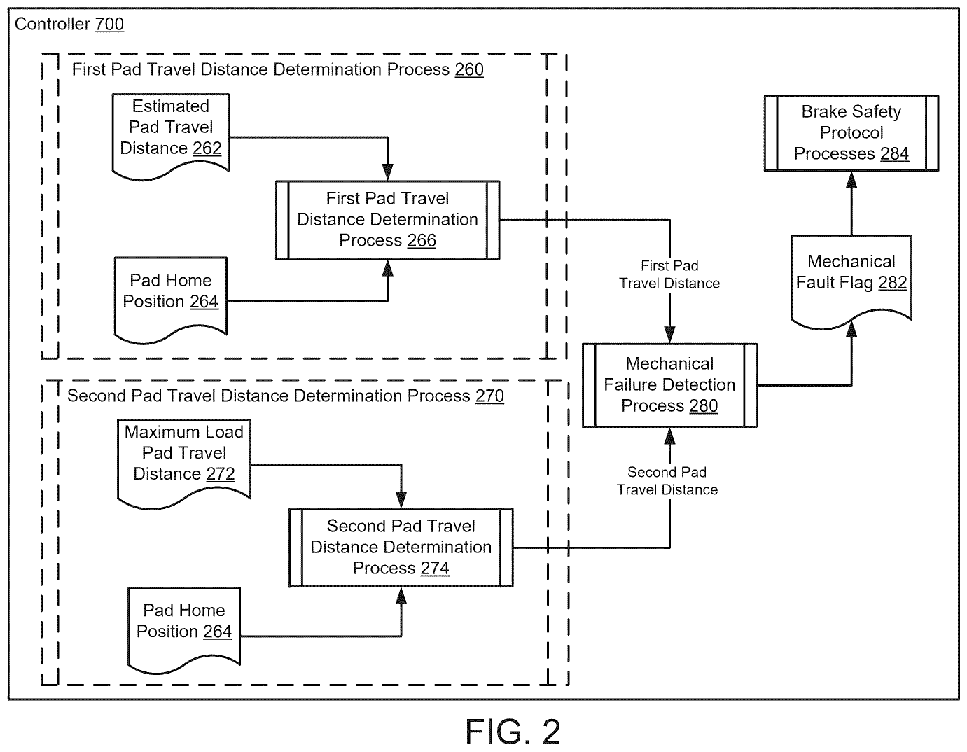

Turning now to FIG. 2, FIG. 2 shows a data flow diagram illustrating a method for mechanical failure detection in a brake assembly according to one or more exemplary embodiments of the present disclosure.

In particular, mechanical failure may include, for example, gear wear and/or slipping in the system (e.g., belt slip) where the electric motor 520 continues to actuate but such continued actuation of the electric motor 520 does not translate to any actual movement of the brake pads of the brake pad assembly 120. Said another way, measurement of the movement of the electric motor 520 may indicate that the brake pads of the brake pad assembly 120 are compressing (i.e., pushing, clamping, or the like) against the brake rotor 125 (i.e., performing braking operations as intended) while in reality the brake pads have had little to no movement at all (i.e., not actually performing any braking operations at all). Other types of mechanical failures that may cause the controller 700 to mistakenly believe that the brake pads of the brake pad assembly 120 are actually operating as intended to apply a braking operation (e.g., a braking force) may also be detected using the method for mechanical failure detection of embodiments disclosed herein.

In this diagram, flows of data and processing of data are illustrated using different sets of shapes. A first set of shapes (e.g., 262, 264, 272, 282, etc.) is used to represent data structures (e.g., files, documents, data packets, or the like), a second set of shapes (e.g., 266, 274, 280, 284 etc.) is used to represent processes performed using and/or that generate data, and a third set of shapes (e.g., 700) is used to represent physical components that perform the processes depicted suing the second set of shapes. Shapes shown using broken lines represent a grouping of one or more components of the data flow diagram. For example, the estimated pad travel distance 262, the pad home position 264, and the first pad travel distance determination process 266 make up the first pad travel distance determination process 260. The data flow diagram of FIG. 2 may be performed by any of the computing-related/computing-enabled components (namely, controller 700 of brake assembly 10) shown in FIG. 1.

In embodiments, the method for mechanical failure detection in a brake assembly shown in FIG. 2 may be performed (e.g., controller 700 of the brake assembly 10) each time the controller 700 detects a braking operation being performed by a driver of the vehicle (or by the vehicle's main controller (e.g., a chassis controller or the like as shown in FIG. 4) if the vehicle is driver less). Said another way, the controller 700 of brake assembly 10 may perform the method shown in FIG. 2 each time the vehicle is braking.

Additionally, although the method of FIG. 2 is described with respect to only one brake pad of the brake pad assembly 120 (e.g., a brake assembly 10 where only one brake pad of the brake pad assembly 120 is moved to cause clamping of the brake rotor 125 by the brake pad assembly 120), embodiments disclosed herein are not limited to such a configuration. If the brake assembly 10 is one where both (i.e., two or multiple) brake pads of the brake pad assembly 120 are moved, then the method of FIG. 2 may be repeated for each brake pad that is configured to be moving (e.g., actuated) during the braking operation of the vehicle.

As shown in FIG. 2, a first pad travel distance determination process 260 may be performed (e.g., by controller 700 of the brake assembly 10). As part of the first pad travel distance determination process 260, an estimated pad travel distance 262 and a pad home position 264 may be obtained (e.g., by controller 700).

In embodiments, the estimated pad travel distance 262 may be an estimated distance that a brake pad (i.e., of the brake pad assembly 120) has traveled during a braking operation. More specifically, the estimated distance that the brake pad has traveled during the braking operation to reach a peak compression of the brake pad against a brake rotor 125 (e.g., the distance traveled between a pad home position (as discussed below) and when the brake pad is released from compressing (e.g., clamping against) the brake rotor 125).

If the brake assembly 10 includes a linear position sensor, this estimated pad travel distance 262 may be measured using the linear position sensor as the amount of distance traveled by the brake pad (e.g., the inboard brake pad of the brake assembly 10 that is moved in the brake apply direction shown in FIG. 1) toward the brake rotor 125 before the brake pad is released from the brake rotor 125.

Alternatively, if the brake assembly 10 does not include a linear position sensor, this estimated pad travel distance 262 may be calculated based on a motor angle of the electric motor 520. For example, each angle of rotation of the electric motor 520 (e.g., from a starting motor angle position) may translate to distance traveled by the brake pad (e.g., 1 degree of translation by the motor may translate to 0.001 mm of distance moved). Thus, a total amount of rotation (e.g., a total amount of rotation) of the electric motor 520 as measured by a motor angle sensor (or the like) between when the brake is applied up to when the brake is released (e.g., when the brake pad starts moving in the brake release direction shown in FIG. 1) may be used to determine the total estimated travel distance of the brake pad that is actuated (e.g., moved, translated, or the like) by the rotation of the electric motor 520.

In embodiments, the pad home position 264 may be the initial, starting position of a brake pad (e.g., namely the inboard brake pad of the brake pad assembly 120 that travels in the brake apply direction) at the start of the braking operation (e.g., when a braking operation is initiated). Said another way, the pad home position 264 may be where this inboard brake pad of the brake pad assembly 120 stopped at the end of the last performed braking operation. For example, assume that the inboard brake pad of the brake pad assembly 120 stopped 0.5 mm away from the brake rotor 125 after the last braking operation has ended, and that this brake pad has not moved (e.g., remained in the same position) since it has stopped. The pad home position 264 in this example may be negative 0.5 mm (i.e., 0.5 mm away from the brake rotor 125).

The pad home position 264 may be obtained from a storage (e.g., memory) of controller 700. This pad home position 264 may be continuously calculated and stored into (e.g., updated into) the storage of controller 700 during each brake operation of the vehicle using one or more other processes (e.g., a pad home detection process or the like) performed by controller 700. Alternatively, a sensor may be provided within brake assembly 10 to measure this pad home position 264.

In embodiments, the estimated pad travel distance 262 and the pad home position 264 may be ingested into first pad travel distance determination process 266 to generate a first pad travel distance. The first pad travel distance may be a sum of the estimated pad travel distance 262 and an absolute value of the pad home position 264. For example, assume that the pad home position 264 is negative 0.5 mm (i.e., the brake pad is 0.5 mm away from the brake rotor 125 at the start of the braking operation) and that the estimated pad travel distance 262 (e.g., based on a motor angle measurement of the electric motor 520) is 1.00 mm. In this example, the first pad travel distance would be equal to 1.50 mm (i.e., first pad travel distance=1.00+|−0.5|).

In embodiments, a second pad travel distance determination process 270 may be performed (e.g., by controller 700 of the brake assembly 10). The second pad travel distance determination process 270 may be performed concurrently with (i.e., in parallel with) the first pad travel distance determination process 266. In the context of embodiments disclosed herein, the second pad travel distance determination process 270 is not the process to determine a travel distance of a second pad (i.e., a different brake pad than the brake pad being measured during the first pad travel distance determination process 260), but rather a second distance determination process for the same brake pad to which the first pad travel distance determination process 260 is applied.

As part of the first pad travel distance determination process 260, a maximum load pad travel distance 272 and the pad home position 264 (i.e., the same pad home position value used as part of the first pad travel distance determination process 260) may be obtained (e.g., by controller 700).

In embodiments, the maximum load pad travel distance 272 may be a value that is pre-stored within the controller 700 by a manufacturer of the brake assembly 10 and/or of the vehicle. Said another way, the maximum load pad travel distance 272 may be a manufacturer-rated value that indicates a maximum pad compression amount exhibited during testing of the braking operation of the vehicle (e.g., the pad travel distance recorded during testing of the brake assembly 10 when the brake pads of the brake pad assembly 120 are applying a peak compression on the brake rotor 125 right before the brake pads loosen and move away from the brake rotor 125 upon termination of the brake operation). For example, for certain brake assemblies 10, the maximum load pad travel distance 272 may be recorded as being 1.40 mm. This maximum load pad travel distance 272 may vary between brake pad assemblies based on the size, components, configuration, and other factors associated with each brake pad assembly.

In embodiments, the maximum load pad travel distance 272 and the pad home position 264 may be ingested into second pad travel distance determination process 274 to generate a second pad travel distance. The second pad travel distance may be a sum of the maximum load pad travel distance 272 and an absolute value of the pad home position 264. For example, assume again that the pad home position 264 is negative 0.5 mm (i.e., the brake pad is 0.5 mm away from the brake rotor 125 at the start of the braking operation) and that the maximum load pad travel distance 272 is 1.40 mm. In this example, the second pad travel distance would be equal to 1.90 mm (i.e., second pad travel distance=1.40+|−0.5|).

In embodiments, this second pad travel distance generated (i.e., calculated) using the second pad travel distance determination process may be used as a maximum pad travel distance threshold for determining whether any mechanical failure (e.g., gear wear, belt slip, or the like) has occurred within the brake assembly 10. Namely, any mechanical failure (e.g., gear wear, belt slip, or the like) may cause a brake pad to travel more than this maximum pad travel distance represented by the second pad travel distance.

To use the second pad travel distance to detect any mechanical failures e.g., gear wear, belt slip, or the like) within the brake assembly 10, the second pad travel distance and the first pad travel distance may be ingested into mechanical failure detection process 280 where the two travel distances are compared to one another. More specifically, the first pad travel distance is compared against the second pad travel distance to see whether the first pad travel distance has exceeded the second pad travel distance. Effectively, the second pad travel distance is used a maximum allowed pad travel distance (i.e., of a brake pad of the brake pad assembly 120) before machinal failure is likely to have occurred within the brake assembly 10.

For example, assume that belt slip or gear wear has occurred within brake assembly 10 (e.g., at drive belt 546 (or alternatively, a gear drive) of the brake assembly 10 of FIG. 1). Such belt slip or gear wear may cause the electric motor 520 to continue to actuate (e.g., rotate) during a braking operation while a brake pad actuated by the electric motor 520 is not moving much or not moving at all. For example, if the drive belt 546 has slipped (e.g., during a belt slip situation) no amount of rotation (e.g., actuation) by the electric motor 520 will cause the brake pad to move (e.g., move linearly toward the brake rotor 125 in the brake apply direction of FIG. 1).

Thus, assume in this belt slip situation that at the end of the braking operation, the motor angle measured translated to a maximum load pad travel of 4.00 mm. Assuming the same conditions above where the second pad travel distance is 1.9 mm and the pad home position 264 is negative 0.5 mm, the first pad travel distance would come out as 4.5 mm, which greatly exceeds the second pad travel distance is 1.9 mm. In such a situation, the controller 700 would know, via mechanical failure detection process 280, that a mechanical failure has occurred (or has potentially occurred) within brake assembly 10 during the braking operation.

Such detection that the mechanical failure has occurred (or has potentially occurred) may cause the controller 700 to generate, as part of mechanical failure detection process 280, a mechanical fault flag 282.

In one or more embodiments, the mechanical failure detection process 280 may include an error counter and the mechanical fault flag 282 may only be generated by the controller 700 when the force error counter is incremented past (e.g., exceeds) a predetermined value. For example, each time the controller 700 determines that a machinal fault has occurred, the force error counter will be incremented by one. Similarly, when the controller determines that no force error has occurred, the force error counter will be decreased by one. In this example, the force error counter may be incremented or reduced (e.g., decreased) only once during each instance of a braking operation of the vehicle.

In embodiments, the error counter may only be used if a difference between the first pad travel distance and the second pad travel distance does not exceed a specific acceptable error threshold value. More specifically, a larger difference may indicate larger possibility of a belt slip rather than just normal gear wear, which is more dangerous than gear wear since the drive belt 546 has partially or completely slipped off such that the brake pads of the brake pad assembly 120 can no longer apply any braking force against the brake rotor 125. Other methods and/or conditions as to when the mechanical fault flag 282 will be generated may also be applied (e.g., depending on factors such as applicable safety standards, compliance requirements, manufacturer requirements, or the like) without departing from the scope of embodiments disclosed herein.

Upon generating mechanical fault flag 282, controller 700 may use mechanical fault flag 282 in one or more brake safety protocol processes 284. For example, in some embodiments, the controller 700 may (upon obtaining mechanical fault flag) cause the brake assembly 10 to enter a safety mode where the brake pad assembly 120 is locked in an open (non-engageable) position relative to the brake rotor 125. The controller 700 may then inform the central controller (e.g., 850 of FIG. 4) of the vehicle of such action of transitioning the brake assembly 10 into the safety mode such that the driver of the vehicle is made aware that at least one brake assembly 10 of the vehicle is no longer operational (and/or functional). In embodiments, the controller 700 may also issue (e.g., transmit, provide, or the like) the mechanical fault flag 282 to the central controller (e.g., 850 of FIG. 4) of the vehicle and (in response) receive instructions from the central controller of the vehicle for the brake assembly 10 to enter (e.g., to place the brake assembly in) the safety mode.

Alternatively, the controller 700 may just forward the mechanical fault flag 282 directly to the central controller and let the driver make a manual determination whether to switch the brake assembly 10 into the safety mode (based on other operating conditions of the vehicle as reported to the driver by the central controller). Other vehicle safety protocols may also be implemented (e.g., as part of brake safety protocol processes 284 of the brake assembly 10) to account for one (or more) of the brake assemblies 10 of the vehicle failing or inferred (e.g., estimated, assumed, or the like) to have failed. For example, another action that could be taken by brake assembly 10 is to cut power to the electric motor 520 from controller 700 such that the electric motor 520 is no longer able to cause the translatable part 240 to actuate toward the brake rotor 125.

Any of the processes illustrated using the second set of shapes (shown in FIG. 2) may be performed, in part or whole, by digital processors (e.g., central processors, processor cores, etc.) that execute corresponding instructions (e.g., computer code/software) of controller 700. Execution of the instructions may cause the digital processors to initiate performance of the processes. Any portions of the processes may be performed by the digital processors and/or other devices. For example, executing the instructions may cause the digital processors to perform actions that directly contribute to performance of the processes, and/or indirectly contribute to performance of the processes by causing (e.g., initiating) other hardware components to perform actions that directly contribute to the performance of the processes.

Any of the processes illustrated using the second set of shapes may be performed, in part or whole, by special purpose hardware components of the controller 700 such as digital signal processors, application specific integrated circuits, programmable gate arrays, graphics processing units, data processing units, and/or other types of hardware components. These special purpose hardware components may include circuitry and/or semiconductor devices adapted to perform the processes. For example, any of the special purpose hardware components may be implemented using complementary metal-oxide semiconductor-based devices (e.g., computer chips).

Any of the data structures illustrated using the first set of shapes may be implemented using any type and number of data structures. Additionally, while described as including particular information, it will be appreciated that any of the data structures may include additional, less, and/or different information from that described above. The informational content of any of the data structures may be divided across any number of data structures, may be integrated with other types of information, and/or may be stored in any location.

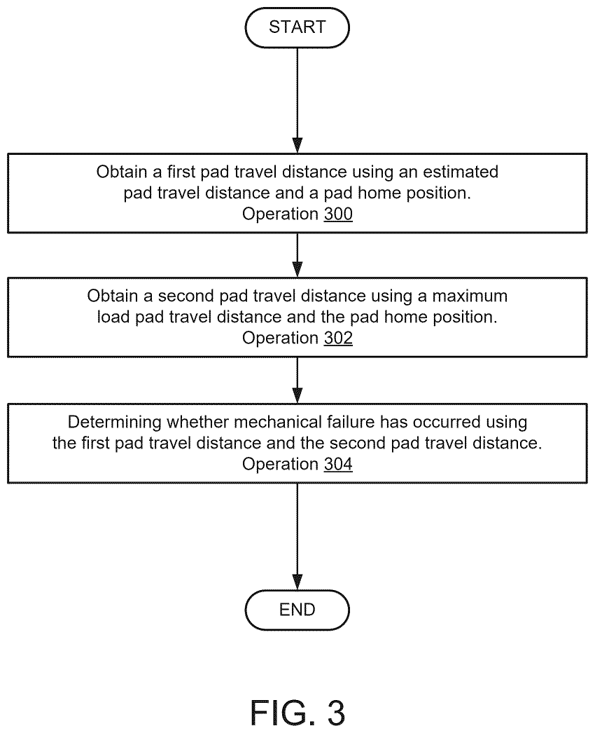

Turning to FIG. 3, a flowchart illustrating a method for detecting mechanical failure in an electromechanical brake (EMB) system according to one or more exemplary embodiments of the present disclosure. The operations of the flowchart of FIG. 3 may be performed, for example, by the controller 700 of the brake assembly 10. Although shown as a series of temporal steps, the operations of the flowchart 3 need not be performed in the exact order shown in FIG. 3 and any of the operations can be performed in any order without departing from the scope and spirit of embodiments disclosed herein.

At Operation 300, and as discussed above in reference to FIG. 2, the controller 700 of brake assembly 10 may obtain a first pad travel distance using an estimated pad travel distance and a pad home position of one or more brake pads (of a brake pad assembly) that are actuated (e.g., moved) during a braking operation of a motor vehicle and/or the brake pad assembly 10.

At Operation 302, and as discussed above in refernce to FIG. 2, the controller 700 of brake assembly 10 may obtain a second pad travel distance using a maximum load pad travel distance and the pad home position of the one or more brake pads that are actuated during the braking operation.

At Operation 304, and as discussed above in refernce to FIG. 2, the controller 700 determine whether mechanical failure of the brake assembly 10 (e.g., belt slip, gear wear, or the like) has occurred using the first pad travel distance and the second pad travel distance.

In embodiments, the method for detecting mechanical failure in the EMB system of FIG. 3 may be performed using a brake assembly 10 that is not configured to include any linear position sensors to measure (e.g., sense) linear movement of the one or more brake pads that are actuated during the braking operation.

In embodiments, the method for detecting mechanical failure in the EMB system of FIG. 3 may be performed each time an instance of the braking operation is performed.

The method of FIG. 3 may end following Operation 304.

Any vehicle according to certain exemplary embodiments of the present disclosure may be identical, or substantially similar to, vehicle 800 shown in FIG. 4. The vehicle 800 may be any passenger or commercial automobile such as a hybrid vehicle, an electric vehicle, or any other type vehicles. FIG. 4 is a schematic view of a vehicle 800 including a steering system and a brake assembly 860 (e.g., the brake assembly 10 discussed above in reference to FIG. 1) according to an exemplary embodiment of the present disclosure. The vehicle 800 may include a steering system 810 for use in a vehicle. The steering system 810 can allow a driver or operator of the vehicle 800 to control the direction of the vehicle 800 or road wheels 830 of the vehicle 800 through the manipulation of a steering wheel 820. The steering wheel 820 is operatively coupled to a steering shaft (or steering column) 822. The steering wheel 820 may be directly or indirectly connected with the steering shaft 822. For example, the steering wheel 820 may be connected to the steering shaft 822 through a gear, a shaft, a belt and/or any connection means. The steering shaft 822 may be installed in a housing 824 such that the steering shaft 822 is rotatable within the housing 824.

The road wheels 830 may be connected to knuckles, which are in turn connected to tie rods. The tie rods are connected to a steering assembly 832. The steering assembly 832 may include a steering actuator motor 834 and steering rods 836. The steering rods 836 may be operatively coupled to the steering actuator motor 834 such that the steering actuator motor 834 is adapted to move the steering rods 836. The movement of the steering rods 836 controls the direction of the road wheels 830 through the knuckles and tie rods.

One or more sensors 840 may be configured to detect position, angular displacement or travel 825 of the steering shaft 822 or steering wheel 820, as well as detecting the torque of the angular displacement. The sensors 840 provide electric signals to a controller 850 indicative of the angular displacement and travel 825. The controller 850 sends and/or receives signals to/from the steering actuator motor 834 to actuate the steering actuator motor 834 in response to the angular displacement 825 of the steering wheel 820.

In the steer-by-wire steering system, the steering wheel 820 may be mechanically isolated from the road wheels 830. For example, the steer-by-wire system has no mechanical link connecting the steering wheel 820 from the road wheels 830. Accordingly, the steer-by wire steering system may comprise a feedback actuator or steering feel actuator 828 comprising an electric motor which is connected to the steering shaft or steering shaft 822. The feedback actuator or steering feel actuator 828 provides the driver or operator with the same “road feel” that the driver receives with a direct mechanical link.

Although the embodiment illustrated in FIG. 4 shows the vehicle 800 having the steer-by-wire steering system, the vehicle 800 may alternatively have a mechanical steering system without departing from embodiments disclosed herein. The mechanical steering system typically includes a mechanical linkage or a mechanical connection between the steering wheel 820 and the road wheels 830. In the mechanical steering system, the steering actuator motor 834 includes an electric motor to provide power to assist the movement of the road wheels 830 in response to the operation of the driver or a control signal of the controller 850. Accordingly, the electric motor can be used as the steering actuator motor 834 or can be included in the feedback actuator or steering feel actuator 828.

Although the example embodiments have been described in detail, it should be understood that various changes, substitutions and alterations can be made herein without departing from the spirit and scope of the present disclosure as defined by the appended claims.

Moreover, the scope of the present application is not intended to be limited to the particular embodiments of the process, machine, manufacture, and composition of matter, means, methods and steps described in the specification. As one of ordinary skill in the art will readily appreciate from the disclosure, processes, machines, manufacture, compositions of matter, means, methods or steps, presently existing or later to be developed, that perform substantially the same function or achieve substantially the same result as the corresponding embodiments described herein may be utilized according to the embodiments and alternative embodiments. Accordingly, the appended claims are intended to include within their scope such processes, machines, manufacture, compositions of matter, means, methods, or steps.

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps.

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. An electromechanical brake (EMB) system comprising:
a brake rotor configured to be rotatable with a wheel of a vehicle;
a brake pad assembly configured to be engageable with the brake rotor;
an actuator assembly comprising an electric motor configured to mechanically move the brake pad assembly toward or away from the brake rotor; and
an electronic control unit (ECU) comprising a processor associated with a memory that stores instructions that when executed by the processor causes the ECU to perform operations comprising:
obtaining a first pad travel distance using an estimated pad travel distance and a pad home position of a brake pad of the brake pad assembly;
obtaining a second pad travel distance using a maximum load pad travel distance and the pad home position of the brake pad; and
determining, using the first pad travel distance and the second pad travel distance, whether mechanical failure has occurred in the EMB system.

2. The EMB system of claim 1, wherein the ECU is configured to perform the operations during a braking operation of the vehicle.

3. The EMB system of claim 2, wherein the second pad travel distance obtained using the maximum load pad travel distance and the pad home position of the brake pad is obtained concurrently with the first pad travel distance obtained using the estimated pad travel distance and the pad home position of the brake pad.

4. The EMB system of claim 3, wherein the pad home position is a distance between the brake rotor and the brake pad at a start of the braking operation of the vehicle before the brake pad is mechanically moved toward the brake rotor by the electric motor.

5. The EMB system of claim 4, wherein the estimated pad travel distance is determined using a motor angle of the electric motor that is measured during the braking operation.

6. The EMB system of claim 5, wherein the maximum load pad travel distance is a predetermined value that is stored in the memory of the ECU and indicates a maximum travel distance of the brake pad for the brake pad to reach a maximum pad compression against the brake rotor during the braking operation of the vehicle.

7. The EMB system of claim 5, wherein the ECU determines that the mechanical failure has occurred in the EMB system when the first pad travel distance exceeds the second pad travel distance.

8. The EMB system of claim 7, wherein the EMB system is a linear-position-sensor-less system that is configured without any sensors that directly measure a linear movement of the brake pad of the brake pad assembly.

9. The EMB system of claim 1, wherein the operations further comprise:
issuing, by the ECU, a mechanical fault flag; and
receiving, in response to the mechanical fault flag, one or more instructions to place the EMB system in a safety mode of the EMB system.

10. The EMB system of claim 9, wherein the mechanical fault flag is issued to a central controller of the vehicle.

11. A method configured to be executed by an electronic control unit (ECU) associated with an electromechanical brake (EMB) system, the method comprising:
obtaining a first pad travel distance using an estimated pad travel distance and a pad home position of a brake pad of a brake pad assembly of the EMB system;
obtaining a second pad travel distance using a maximum load pad travel distance and the pad home position of the brake pad; and
determining, using the first pad travel distance and the second pad travel distance, whether mechanical failure has occurred within the EMB system,
wherein the EMB system comprises a brake rotor configured to be rotatable with a wheel of a vehicle on which the EMB system is installed, the brake pad assembly configured to be engageable with the brake rotor, and an actuator assembly comprising an electric motor configured to mechanically move the brake pad assembly toward or away from the brake rotor.

12. The method of claim 11, wherein the ECU determines whether the mechanical failure has occurred, using the first pad travel distance and the second pad travel distance, during a braking operation of the vehicle.

13. The method of claim 12, wherein the second pad travel distance obtained using the maximum load pad travel distance and the pad home position of the brake pad is obtained concurrently with the first pad travel distance obtained using the estimated pad travel distance and the pad home position of the brake pad.

14. The method of claim 13, wherein the pad home position is a distance between the brake rotor and the brake pad at a start of the braking operation of the vehicle before the brake pad is mechanically moved toward the brake rotor by the electric motor.

15. The method of claim 14, wherein the estimated pad travel distance is determined using a motor angle of the electric motor that is measured during the braking operation.

16. The method of claim 15, wherein the maximum load pad travel distance is a predetermined value that is stored in a memory of the ECU and indicates a maximum travel distance of the brake pad for the brake pad to reach a maximum pad compression against the brake rotor during the braking operation of the vehicle.

17. The method of claim 15, wherein the ECU determines that the mechanical failure has occurred in the EMB system when the first pad travel distance exceeds the second pad travel distance.

18. The method of claim 17, wherein the EMB system is a linear-position-sensor-less system that is configured without any sensors that directly measure a linear movement of the brake pad of the brake pad assembly.

19. The method of claim 11, further comprising:
issuing, by the ECU, a mechanical fault flag; and
receiving, in response to the mechanical fault flag, one or more instructions to place the EMB system in a safety mode of the EMB system.

20. The method of claim 19, wherein the mechanical fault flag is issued to a central controller of the vehicle.
